(19) United States
(12) Patent Application Publication
(10) Pub. No.: US 2016/0091966 A1
(43) Pub. Date: Mar. 31, 2016

(54) STEREOSCOPIC TRACKING STATUS INDICATING METHOD AND DISPLAY APPARATUS

(71) Applicant: SuperD Co. Ltd., Shenzhen (CN)

(72) Inventors: XIAOMING LI, Shenzhen (CN); HAIYU FAN, Shenzhen (CN)

(73) Assignee: SuperD Co., Ltd.

(21) Appl. No.: 14/713,484

(22) Filed: May 15, 2015

(30) Foreign Application Priority Data
Sep. 26, 2014 (CN) 2014-10504748.5
Sep. 26, 2014 (CN) 2014-10504816.8

(51) Int. Cl. G06F 3/01; H04N 13/04; G06K 9/00

(52) U.S. Cl. CPC G06F 3/012; G06K 9/00221; H04N 13/0497; H04N 13/0422

(57) ABSTRACT

A stereoscopic tracking status indicating method is provided. The method includes tracking information of a user's face by a three-dimensional (3D) display apparatus. The method also includes generating abnormal status indicating information when the information of the user's face is not tracked, where the abnormal status indicating information indicates that the information of the user's face is not tracked. Further, the method includes presenting the abnormal status indicating information to the user, such that the user is prompted to adjust a position of the user's face based on the abnormal status indicating information.

### CROSS-REFERENCES TO RELATED APPLICATIONS

This PCT application claims priority of Chinese Application No. 201410504748.5 filed on Sep. 26, 2014, and priority of Chinese Application No. 201410504816.8 filed on Sep. 26, 2014, the entire contents of all of which are hereby incorporated by reference.

### FIELD OF THE INVENTION

The present disclosure generally relates to the field of display technologies and, more particularly, relates to stereoscopic tracking status indicating methods and display apparatuses.

### BACKGROUND

In stereoscopic display (also called three-dimensional display) technologies, human-computer interaction is not restricted to two-dimensional spaces. In order to achieve a sense of reality, interaction in three-dimensional (3D) scales should be combined closely with visual effects. When a user views 3D images or edits image data through viewing a 3D image display apparatus, in order to achieve a desired 3D viewing effect, the user needs to be located within a desired 3D display viewing area.

However, the user may not know whether he/she is located within the desired 3D display viewing area. Therefore, it requires a method and display apparatus for indicating status of the user through tracking position information of the user's face.

The disclosed methods and apparatuses are directed to solve one or more problems set forth above and other problems. For example, the disclosed methods and apparatuses can provide technical solutions for achieving a desired viewing effect in a 3D system. The disclosed methods may be applied to any 3D system to display 3D images.

### BRIEF SUMMARY OF THE DISCLOSURE

One aspect of the present disclosure includes a stereoscopic tracking status indicating method. The method includes tracking information of a user's face by a three-dimensional (3D) display apparatus. The method also includes generating abnormal status indicating information when the information of the user's face is not tracked, where the abnormal status indicating information indicates that the information of the user's face is not tracked. Further, the method includes presenting the abnormal status indicating information to the user, such that the user is prompted to adjust a position of the user's face based on the abnormal status indicating information.

Another aspect of the present disclosure includes a display apparatus to display a three-dimensional (3D) image. The display apparatus includes a tracking unit configured to track information of a user's face. The display apparatus also includes an abnormal information generation unit configured to, when the information of the user's face is not tracked, generate abnormal status indicating information, where the abnormal status indicating information indicates that the information of the user's face is not tracked. Further, the display apparatus includes an information transmission unit configured to transmit the abnormal status indicating information to the user, such that the user is prompted to adjust a position of the user's face based on the abnormal status indicating information.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates an exemplary environment incorporating certain embodiments of the present invention;

FIG. 2 illustrates a flow chart of an exemplary stereoscopic tracking status indicating process consistent with the disclosed embodiments;

FIG. 3 illustrates a flow chart of another exemplary stereoscopic tracking status indicating process consistent with the disclosed embodiments;

FIG. 4A illustrates a schematic diagram of an exemplary tracking status indicating information consistent with the disclosed embodiments;

FIG. 4B illustrates a schematic diagram of another exemplary tracking status indicating information consistent with the disclosed embodiments;

FIG. 4C illustrates a schematic diagram of another exemplary tracking status indicating information consistent with the disclosed embodiments;

FIG. 5A illustrates a schematic diagram of showing an application scene of normal status indicating information consistent with the disclosed embodiments;

FIG. 5B illustrates a schematic diagram of showing an application scene of abnormal status indicating information consistent with the disclosed embodiments;

FIG. 6 illustrates a flow chart of another exemplary stereoscopic tracking status indicating process consistent with the disclosed embodiments;

FIG. 7 illustrates a flow chart of another exemplary stereoscopic tracking status indicating process consistent with the disclosed embodiments;

FIG. 8 illustrates a schematic diagram of an exemplary method for setting a 3D display viewing area in a stereoscopic tracking status indicating process consistent with the disclosed embodiments;

FIG. 9A illustrates a schematic diagram of an exemplary abnormal and normal status indicating information consistent with the disclosed embodiments;

FIG. 9B illustrates a schematic diagram of another exemplary abnormal and normal status indicating information consistent with the disclosed embodiments;

FIG. 9C illustrates a schematic diagram of another exemplary abnormal and normal status indicating information consistent with the disclosed embodiments;

FIG. 10A illustrates a schematic diagram of an exemplary implementing process for displaying normal status indicating information consistent with the disclosed embodiments;

FIG. 10B illustrates a schematic diagram of another exemplary implementing process for displaying normal status indicating information consistent with the disclosed embodiments;

FIG. 10C illustrates a schematic diagram of another exemplary implementing process for displaying normal status indicating information consistent with the disclosed embodiments;

FIG. 10D illustrates a schematic diagram of another exemplary implementing process for displaying normal status indicating information consistent with the disclosed embodiments;

FIG. 11A illustrates a schematic diagram of an exemplary implementing process for displaying abnormal status indicating information consistent with the disclosed embodiments;

FIG. 11B illustrates a schematic diagram of another exemplary implementing process for displaying abnormal status indicating information consistent with the disclosed embodiments;

FIG. 11C illustrates a schematic diagram of another exemplary implementing process for displaying abnormal status indicating information consistent with the disclosed embodiments;

FIG. 11D illustrates a schematic diagram of another exemplary implementing process for displaying abnormal status indicating information consistent with the disclosed embodiments;

FIG. 12A illustrates a schematic diagram of an exemplary way for displaying status indicating information consistent with the disclosed embodiments;

FIG. 12B illustrates a schematic diagram of another exemplary way for displaying status indicating information consistent with the disclosed embodiments;

FIG. 12C illustrates a schematic diagram of another exemplary way for displaying status indicating information consistent with the disclosed embodiments;

FIG. 13 illustrates a structure diagram of an exemplary display apparatus consistent with the disclosed embodiments;

FIG. 14 illustrates a structure diagram of another exemplary display apparatus consistent with the disclosed embodiments; and

FIG. 15 illustrates a structure diagram of an exemplary computing system consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of this disclosure.

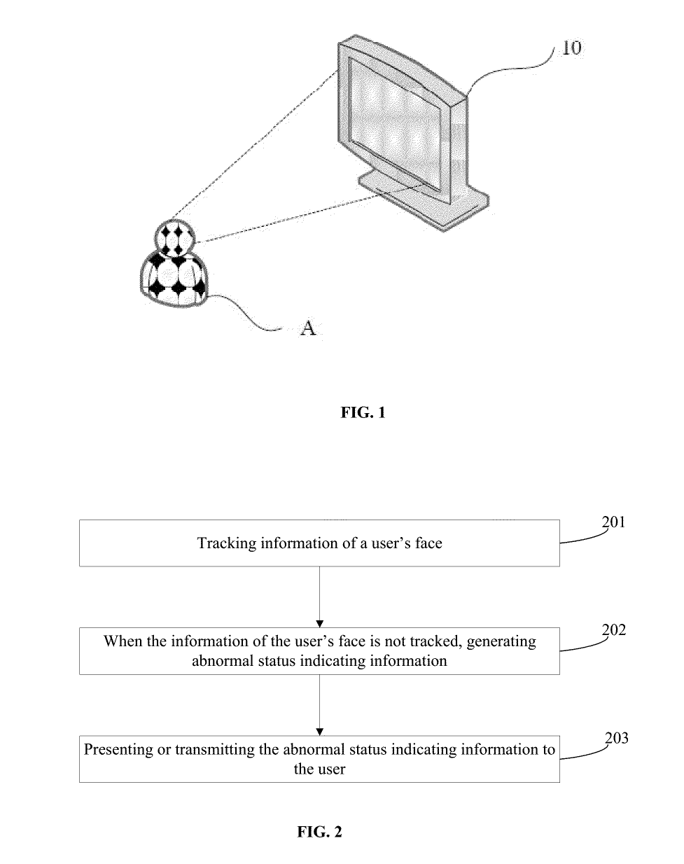

FIG. 1 illustrates an exemplary environment incorporating certain embodiments of the present invention. As shown in FIG. 1, environment 100 includes a display apparatus 10 (e.g., a television set (TV)) and a user A. Other devices (e.g., a remote control) may also be included.

The display apparatus 10 may include any appropriate type of display apparatus with a three-dimensional (3D) display function or any appropriate type of display apparatus with a two-dimensional (2D) and 3D display function, such as a television set (TV), an all-in-one personal computer (PC), a tablet computer, a laptop, a smartphone and a game machine. In general, a user A is located at a position in front of a display screen of the display apparatus 10, viewing a 3D image displayed by the display apparatus 10. However, due to the characteristics of 3D display, the user may be unable to always obtain a desired 3D viewing effect when the user is located in front of the display screen of the display apparatus 10. Only when the user is located within a preset area in front of the display screen of the display apparatus 10, the user can obtain the desired 3D viewing effect. When the user is located outside the preset area, the display apparatus needs to prompt the user to adjust his/her position, especially the position of the user's face, such that the user can obtain the desired 3D viewing effect.

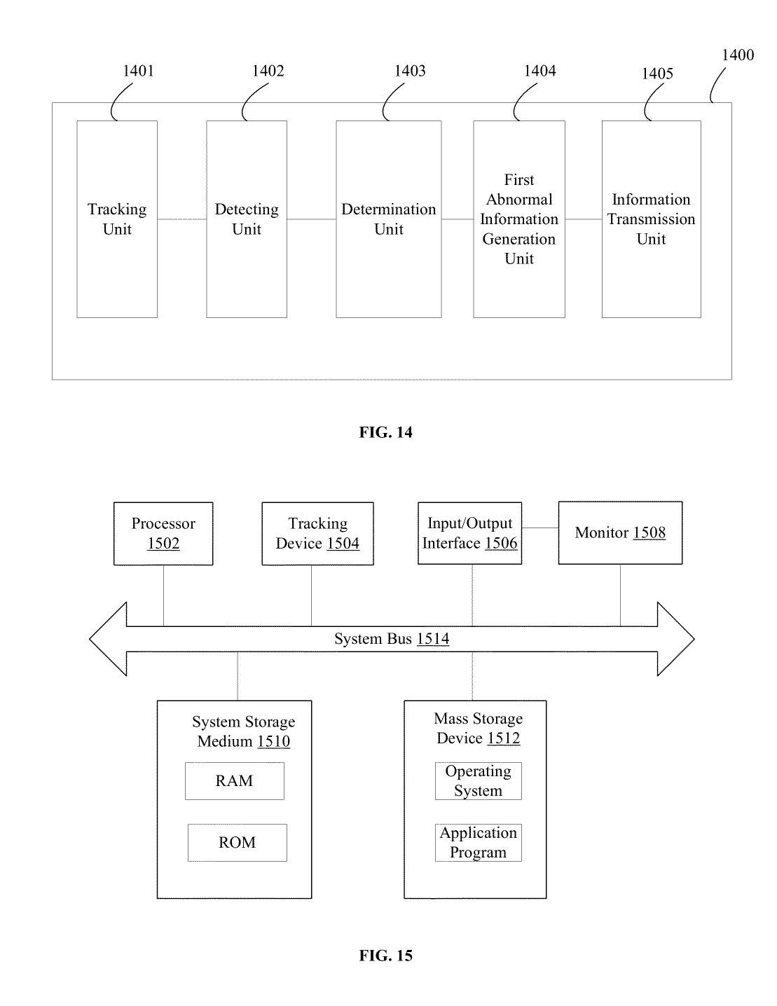

FIG. 15 illustrates a structure diagram of an exemplary computing system consistent with the disclosed embodiments. The computing system may be, but is not limited to, electronic devices with a 3D display function, such as smartphones, personal computers, computer monitors and LCD TVs.

As shown in FIG. 15, the computing system may include a processor 1502, a tracking device 1504, an input/output interface 1506, a monitor 1508, system storage medium 1510, a mass storage device 1512, and one or more system buses 1514. The tracking device 1504, the system storage medium 1510 and the monitor 1508 may be connected to the processor 1502 via system buses 1514. Certain devices may be omitted and other devices may be included.

The processor 1502 may include any appropriate processor or processors. Further, the processor 1502 can include multiple cores for multi-thread or parallel processing. The system storage medium 1510 may include computer storage media in the form of volatile and/or nonvolatile memory such as read only memory (ROM) and random access memory (RAM). A basic input/output system (BIOS), containing the basic routines that help to transfer information between elements within the processor, such as during start-up, is typically stored in ROM. RAM typically contains data and/or program modules that are immediately accessible to and/or presently being operated on by the processor. By way of example, and not limitation, operating systems, application programs, other program modules and program data may be store in the mass storage device (e.g., CD-ROM, hard disk, etc.).

The mass storage device 1512 may be connected to the processor through a mass storage controller (not shown in FIG. 15) on a system bus. The mass storage device 1512 and the associated computer storage media may also include other removable/non-removable, volatile/nonvolatile computer storage media. The associated computer storage media may be any storage media that can be accessed by the computer. The hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD-ROM or other optical media. Other removable/non-removable, volatile/nonvolatile computer storage media that can be used in the exemplary operating environment include, but are not limited to, RAM, ROM, EEPROM, flash memory or other solid state memory technology (e.g., solid state RAM, solid state ROM), CD-ROM, digital versatile disks (DVD) or other optical disk storage, magnetic cassettes, magnetic tape, magnetic disk storage or other magnetic storage devices, or any other medium which can be used to store the desired information and which can accessed by the computer.

The computer may operate in a network environment using logical connections to remote computers through a network, such as a local network, the Internet, etc. For example, the computer may be connected to the network through a network interface unit connected to the bus. The computer may also include an input/output controller for receiving and processing input from a number of other devices, including a keyboard, a mouse (not shown in FIG. 15). Similarly, an input/output controller may provide output to a display screen, a printer, or other types of output devices (not shown in FIG. 15). The monitor 1508 may be also connected to the system bus via a graphic interface or a graphic processing unit (not shown in FIG. 15). The monitor may also be integrated with a touch-screen panel.

Specifically, the computing system includes an image acquisition device (e.g., a camera) which is configured to capture the image of the user's face in real-time. Then, after the processor performs analysis for the image data, the position information of the user's face is obtained. In various embodiments, optionally, the display apparatus can also include devices for indicating the tracking status, such as a speaker, an LED light, a vibrating motor, and so on.

As mentioned above, a number of program modules and data files may be stored in the mass storage device and RAM of the computer, including an operating system suitable for controlling the operation of a networked personal computer. The mass storage device, ROM and RAM may also store one or more program modules. In particular, the mass storage device, ROM and RAM may store application programs executed by the processor.

The system storage medium 1510 is configured to store computer programs, and the processor 1502 is configured to call the computer programs to perform the following operations: tracking information of a user's face through the tracking device 1504; detecting position information of the user's face relative to the 3D display apparatus when the information of the user's face is tracked; based on the position information of the user's face, determining whether the user's face is located in a preset 3D display viewing area; generating first type of abnormal status indicating information when the user's face is not located in the preset 3D display viewing area, where the first type of abnormal status indicating information indicates that the user's face is located outside the preset 3D display viewing area; and transmitting the first type of abnormal status indicating information to the user, such that the user is prompted to adjust the position of his/her face based on the first type of abnormal status indicating information.

In addition, when the user's face is located in the preset 3D display viewing area, the processor 1502 also calls the computer programs to generate normal status indicating information, where the normal status indicating information indicates that the user's face is located in the preset 3D display viewing area. Then, the normal status indicating information is transmitted to the user through the input/output interface 1506, prompting the user that he/she is located in the preset 3D display viewing area.

When the user's face cannot be tracked by the tracking device 1504 (e.g., image acquisition device), the processor also calls the computer programs to generate a second type of abnormal status indicating information, where the second type of abnormal status indicating information indicates that the user's face is located outside the tracking area. Then, the second type of abnormal status indicating information is transmitted to the user through the input/output interface, prompting the user to adjust his/her position based on the second type of abnormal status indicating information. Further, the image acquisition device captures an image of the user's face. Based on the image of the user's face, the processor calculates the position information of the user's face relative to the 3D display apparatus.

Moreover, the first type of abnormal status indicating information and the second type of abnormal status indicating information may include at least one type of direction icons, gesture icons, face icons and color icons. Or, the first type of abnormal status indicating information and the second type of abnormal status indicating information may include at least one type of indicator lights, warning tones and graphic icons. Based on different display mode of the abnormal status indicating information, different hardware is configured. For example, when a speaker is configured, the abnormal status indicating information is displayed to the user through a warning tone.

In this disclosure, the 3D display viewing area is a desired 3D display viewing area; and the desired 3D display viewing area is delimited based on a viewing angle of the image acquisition device. The first type of abnormal status indicating information is displayed through a simulating user area and a simulating preset 3D display viewing area. The simulating user area is used to simulate the user area using an image mode and the simulating preset 3D display viewing area is used to simulate the preset 3D display viewing area using the image mode.

Through the 3D display apparatus provided in this disclosure, position information of the user's face relative to the 3D display apparatus is detected by the image acquisition device associated with the 3D display apparatus. Based on the position information of the user's face, whether the user's face is located in the preset 3D display viewing area is determined. When the user's face is not located in the preset 3D display viewing area, the abnormal status indicating information is generated and transmitted to the user, thereby prompting the user to adjust the position of his/her face based on the abnormal status indicating information. Therefore, the position of the user's face is in the preset 3D display viewing area, obtaining a desired 3D viewing effect and improving the user experience.

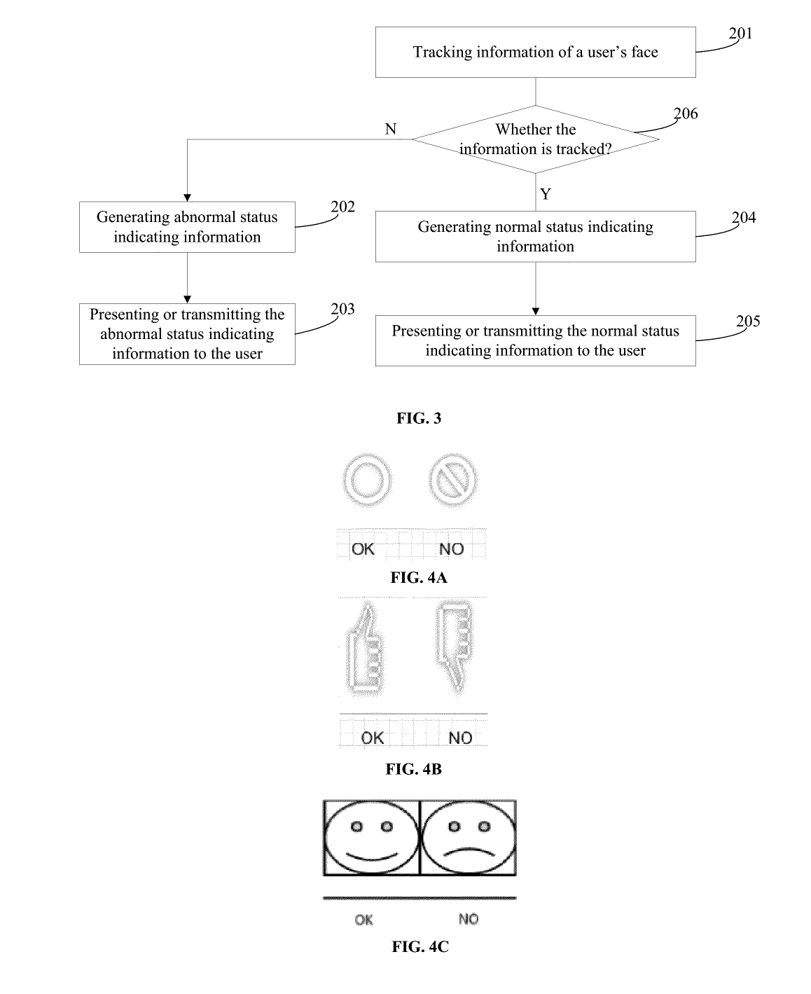

FIG. 2 illustrates a flow chart of an exemplary stereoscopic tracking status indicating process consistent with the disclosed embodiments. As shown in FIG. 2, the process may include the following steps.

Step 201: information of a user's face is tracked by a 3D display apparatus.

In Step 201, the 3D display apparatus may track the user's face through a tracking device to obtain the track information of the user. For example, an image acquisition device (e.g., a camera) may be used to track the information of the user's face; infrared sensors may be configured on the 3D display apparatus to track the information of the user's face; or ultrasonic transmitters may be installed on the 3D display apparatus to track the information of the user's face. The image acquisition device includes, but is not limited to, a camera. The camera may be integrated in the 3D display apparatus, and may be an external camera electrically connected to the 3D display apparatus, as long as the camera can track position information of the user relative to the 3D display apparatus. The connection between the camera and the 3D display apparatus should not be considered as limiting the scope of the disclosure.

When the infrared sensors are used to track the information of the user's face, a row of infrared sensors can be configured on the 3D display apparatus. A filter is arranged in front of the infrared sensors, and light transmitting holes are set on the filter, such that the infrared ray emitted by human body can transmit through the light transmitting holes and can be sensed by some of the infrared sensors among the row of the infrared sensors. The 3D display apparatus can perform analysis based on change of the infrared sensors, thereby implementing tracking for the information of the user's face.

In addition, the ultrasonic transmitters may be installed on the 3D display apparatus to track the information of the user's face. For example, one or more ultrasonic transmitters are set at a selected position of the 3D display apparatus. The ultrasonic transmitter emits an ultrasonic wave. The ultrasonic wave is returned to the 3D display apparatus after being reflected by the human body. The position of the user can be calculated by using time and transmission speed of the ultrasonic wave. Also, the information of the user's face can be further tracked according to an emission angle of the ultrasonic wave.

It should be noted that, in the process for tracking the user's face, there exists a tracking area. The tracking area may be an area within which the 3D display apparatus can track the head of the user. The tracking area may be different according to different devices used in the tracking method. For example, when an image acquisition device is used, the tracking area is the area within which the image acquisition device can capture an image of the user and, when infrared sensors are used, the tracking area is the area within which the infrared sensors can receive the infrared ray emitted by the human body.

Step 202: when the information of the user's face is not tracked, abnormal status indicating information is generated, where the abnormal status indicating information indicates that the information of the user's face is not tracked.

In general, there may be two reasons why the information of the user's face is not tracked.

The first reason is that the user is located outside the tracking area. In this case, as tracking technologies are different, different display apparatus may have different tracking areas. For example, when an image acquisition device is used to track the user's face, the tracking area is the area within which the image acquisition device can capture an image of the user's face. When infrared sensors are used to track the user's face, the tracking area is the area within which the infrared ray emitted by the user's body can be received by the infrared sensors configured on the 3D display apparatus. When an ultrasonic transmitter is used to track the user's face, the tracking area is the area that can be reached by the ultrasonic wave emitted from the ultrasonic transmitter. In general, if the user is located within the tracking area, the user can be tracked.

The second reason is that the user is located within the tracking area, but cannot be tracked. For example, when the image acquisition device is used to track the user's face, because light intensity in the environment exceeds a threshold, contour feature points of the user's face are not obvious and the information of the user's face cannot be tracked; or because the user's face is blocked by at least one obstacle (e.g., hair, sunglasses, and so on), the information of the user's face cannot be tracked. When the infrared sensors are used to track the user's face, because another interference source which can emit infrared rays exists within the tracking area, the infrared sensors are disturbed and the tracking fails.

In Step 202, the 3D display apparatus generates the abnormal status indicating information. The abnormal status indicating information prompts the user that the information of the user's face is not tracked. The abnormal status indicating information may be one or more type of warning tone sounded by a speaker, light emitted by a light emitting diode (LED) light, graphic icon, photo or text.

Step 203: the abnormal status indicating information is presented or transmitted to the user.

In Step 203, the 3D display apparatus presents or transmits the abnormal status indicating information to the user according to the type of the abnormal status indicating information. For example, a speaker sounds warning tone; an LED light flashes; a screen of the display apparatus displays graphic, icon or text.

Specifically, the way that the 3D display apparatus presents or transmits the abnormal status indicating information to the user may include, but is not limited to, the followings.

1. The abnormal status indicating information is transmitted to the user through a user interface (UI).

When the UI is used to transmit the abnormal status indicating information to the user, at least one type of direction icons, gesture icons, face icons, color icons and text may be used to display the abnormal status indicating information. Therefore, the user is prompted that the information of the user's face is not tracked. Transmitting the abnormal status indicating information through the UI is a more intuitive way without the need of configuring additional hardware.

2. The abnormal status indicating information is transmitted to the user through an indicator light (e.g., an LED light).

Specifically, a set of LED lights are set on the 3D display apparatus to indicate the abnormal status. For example, the user may be prompted through light flashing or light color.

Of course, any other indicator light may be used to prompt the user. Further, different color combinations may have different prompting effects. Also, the color change may bring significant changes to the space where the user locates, and the prompting effect may be effective.

3. The abnormal status indicating information is transmitted to the user through a speaker.

Specifically, a speaker integrated in the display apparatus or an independent speaker may be used to present the abnormal status indicating information. The specific way may include voice broadcasting, such as buzz and whistle.

Through the above embodiments, the 3D display apparatus determines whether the information of the user's face is tracked based on the tracking result. When the information of the user's face is not tracked, the 3D display apparatus transmits the abnormal status indicating information to the user. The user is prompted to adjust the position. Therefore, the user can obtain a desired 3D viewing effect. The abnormal status indicating information is directly transmitted to the user through the speaker, which may be a more intuitive way.

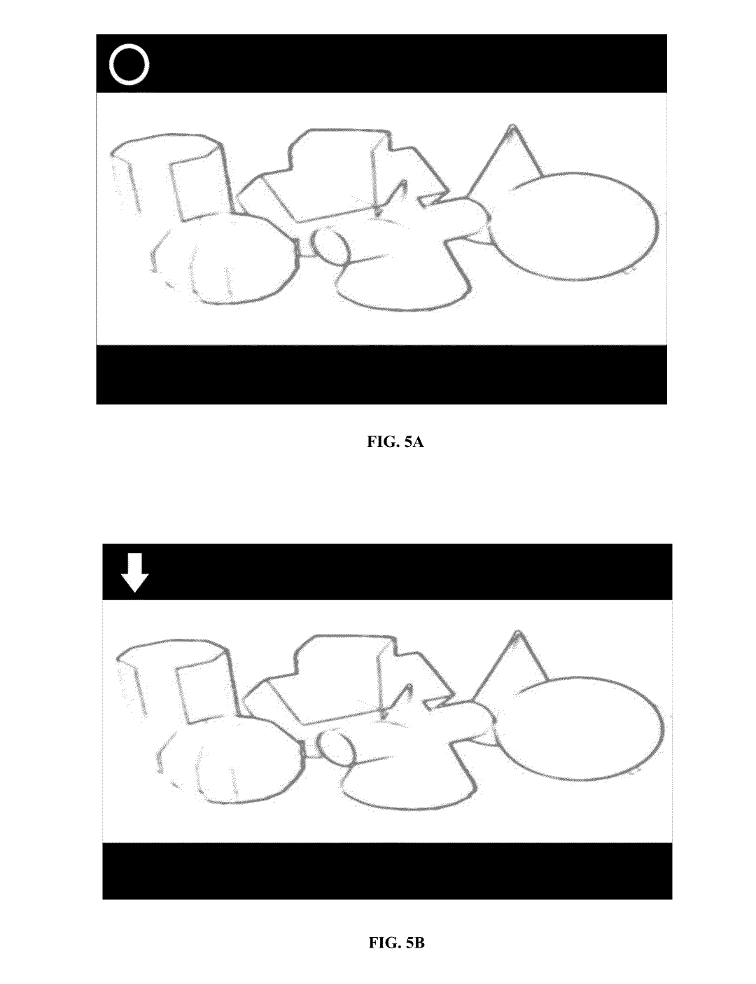

FIG. 3 illustrates a flow chart of another exemplary stereoscopic tracking status indicating process consistent with the disclosed embodiments. As shown in FIG. 3, after Step 201 is performed (above in FIG. 2), the process may include the following steps.

Step 206: whether the information of the user's face is tracked by the display apparatus is determined. When the information of the user's face is not tracked, the process goes to Step 202. When the information of the user's face is tracked, the process goes to Step 204.

Step 204: when the information of the user's face is tracked, normal status indicating information is generated, wherein the normal status indicating information indicates that the information of the user's face is tracked.

Step 205: the normal status indicating information is presented or transmitted to the user.

Similar to the previous embodiments described with FIG. 2, the normal status indicating information may be one of or a combination of two or more of tone, LED indicator light, graphic icon, image and text. Further, the content of the normal status indicating information is different from the content of the abnormal status indicating information. For example, when the speaker is used, if harsh sound is used to represent the abnormal status indicating information, musical bell may be used to represent the normal status indicating information; when the graphic icon is used, if a crying face is used to represent the abnormal status indicating information, a smiley face may be used to represent the normal status indicating information; when the LED indicator lights are used, if a green indicator light is used to represent the normal status indicating information, a red indicator light is used to represent the abnormal status indicating information.

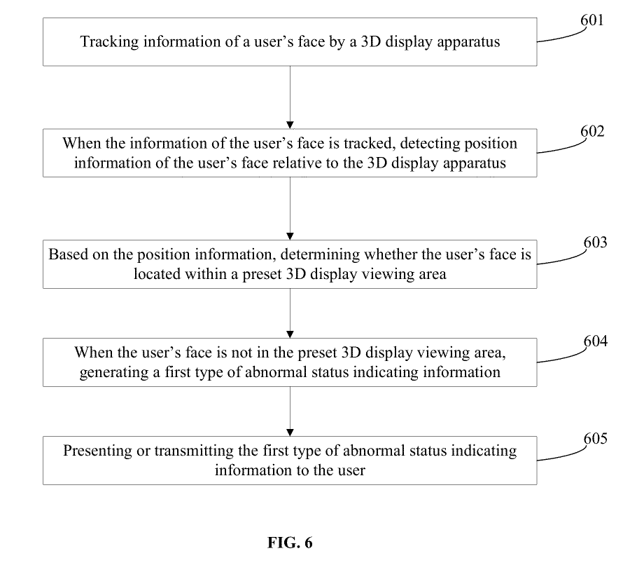

FIGS. 4A to 4C illustrate schematic diagrams of exemplary tracking status indicating information consistent with the disclosed embodiments. In one embodiment, the abnormal status indicating information and the normal status indicating information include graphic icons. Based on different applications, different icons may be selected, such as circular icons shown in FIG. 4A, gesture icons shown in FIG. 4B and face icons shown in FIG. 4C.

In FIG. 4A, the first icon (“O”) may represent the normal status indicating information, which means that the information of the user's face is tracked and the user may have a desired 3D viewing experience when keeping the current position. The other icon (“ [symbol] ”) represents the abnormal status indicating information, which means that the information of the user's face is not tracked.

In FIG. 4B, the first gesture icon (“thumb up”) may represent the normal status indicating information, which means that the information of the user's face is tracked and the user may have a desired 3D viewing experience when keeping the current position. The other gesture icon (“thumb down”) represents the abnormal status indicating information, which means that the information of the user's face is not tracked.

In FIG. 4C, the first face icon (“smiley face”) may represent the normal status indicating information, which means that the information of the user's face is tracked and the user may have a desired 3D viewing experience when keeping the current position. The second face icon (“sad face”) represents the abnormal status indicating information, which means that the information of the user's face is not tracked.

Of course, any status indicated through icons shown in FIGS. 4A to 4C is only illustrative. In practical applications, the status can be displayed through combining the icons with different colors or combining the icons with text, such as a text prompt and an icon prompt manner.

In addition, when the image acquisition device is used to track the user's face, the display apparatus may directly display the user's face on the screen of the display apparatus, thereby prompting the user that the tracking is successful.

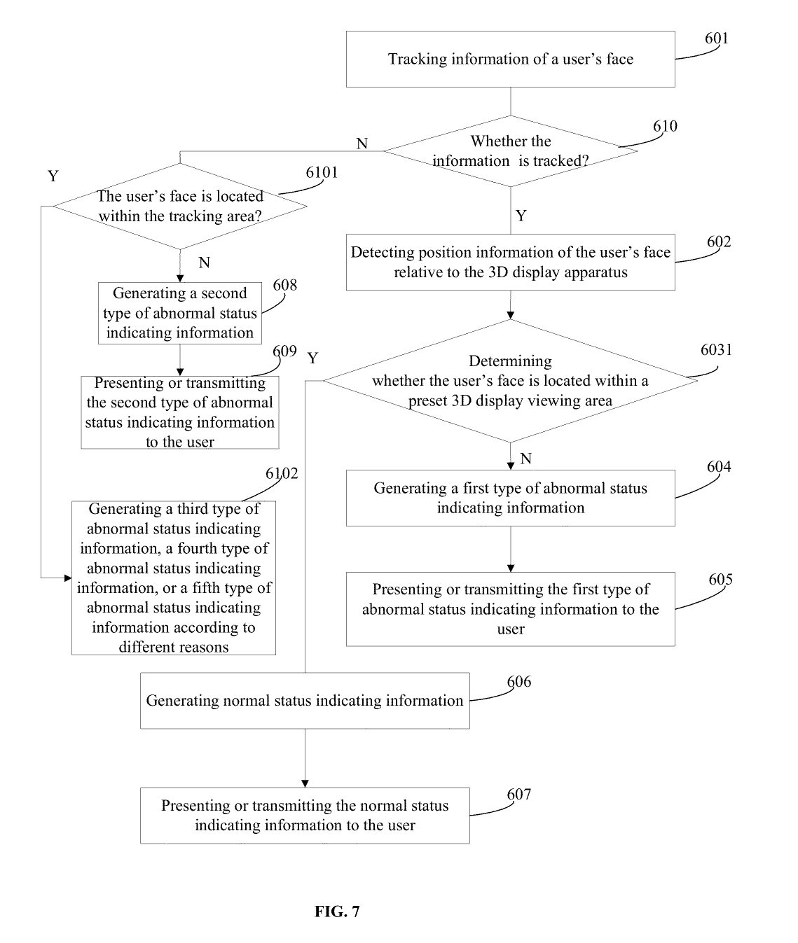

It should be noted that the display position of every icon shown in FIGS. 4A to 4C may be set at any position of the display screen of the display apparatus, but the display position of the icon should not affect the user to view the image data. For example, as shown in FIGS. 5A and 5B, in a scene that the user views a 3D movie or views 3D images through a 3D display apparatus, an icon (“O”) representing the normal status indicating information is displayed at the upper left edge of a display interface of the 3D display apparatus, while a direction arrow (“downward arrow”) representing the abnormal status indicating information is displayed at the upper left edge of the display interface of the 3D display apparatus. Optionally, the icon can be semi-transparent, such that it can achieve an eye-catching effect without affecting the user to view the 3D images.

As described in previous embodiments, because the tracking technologies are different, even if the user is located within the tracking area, the information of the user's face may be not tracked.

In one embodiment, when the user's face is located outside the tracking area and the information of the user's face is not tracked, a second type of abnormal status indicating information may be generated as the abnormal status indicating information. The second type of abnormal status indicating information indicates that the user's face is located outside the tracking area. The user is prompted to adjust his/her position, such that the user's face is located within the tracking area. Through the second type of abnormal status indicating information, the user knows that he/she is located outside the tracking area and needs to adjust his/her own position.

When the user's face is located within the tracking area and the information of the user's face is not tracked, a third type of abnormal status indicating information, a fourth type of abnormal status indicating information, and a fifth type of abnormal status indicating information may be generated as the abnormal status indicating information according to different reasons causing the situation.

Specifically, when the user's face is located within the tracking area, but the information of the user's face is not tracked because of one or more obstacles, the third type of abnormal status indicating information is generated. When the user's face is located within the tracking area, but the information of the user's face is not tracked because light intensity exceeds a threshold, the fourth type of abnormal status indicating information is generated. When the user's face is located within the tracking area, but the user's face is not tracked because of another interference source, the fifth type of abnormal status indicating information is generated.

Through the third type of abnormal status indicating information, the fourth type of abnormal status indicating information and the fifth type of abnormal status indicating information, the user knows that he/she is still within the tracking area and there is no need to adjust the position. However, the user needs to check reasons causing the situation, such that the user's face can be tracked. Therefore, the user's experience is improved.

Different types of abnormal status indicating information can be presented in various ways. For example, when graphic icons are used to indicate the abnormal information, the second type of abnormal status indicating information, the third type of abnormal status indicating information, the fourth type of abnormal status indicating information and the fifth type of abnormal status indicating information can be distinguished using different colors. As shown in FIG. 4A, the second icon (“ [symbol] ”) represents the abnormal status indicating information. In order to distinguish the second type of abnormal status indicating information, the third type of abnormal status indicating information, the fourth type of abnormal status indicating information and the fifth type of abnormal status indicating information, yellow icon may be used to represent the second type of abnormal status indicating information, and red icon may be used to represent one of the third type of abnormal status indicating information, the fourth type of abnormal status indicating information, and the fifth type of abnormal status indicating information (that is, the user's face is located within the tracking area and the information of the user's face is not tracked).

Similarly, when the indicator light is used, the second type of abnormal status indicating information, the third type of abnormal status indicating information, the fourth type of abnormal status indicating information, and the fifth type of abnormal status indicating information may be distinguished using different color of flashing light. When the speaker is used, the second type of abnormal status indicating information, the third type of abnormal status indicating information, the fourth type of abnormal status indicating information, and the fifth type of abnormal status indicating information may be distinguished using sound broadcasting.

Further, in one embodiment, the information of the user's face is tracked using an image acquisition device. When the user's face is located within the tracking area, but the information of the user's face is not tracked because of one or more obstacles, the third type of abnormal status indicating information is generated. The third type of abnormal status indicating information is used to prompt the user to remove the obstacle, such that the user's face can be tracked. When the user's face is located within the tracking area, but the information of the user's face is not tracked because the light intensity exceeds the threshold (e.g., an opto-sensor is used to measure light intensity in the current environment), the fourth type of abnormal status indicating information is generated. The fourth type of abnormal status indicating information is used to prompt the user to adjust the light intensity, such that the user's face can be tracked.

Similarly, the third type of abnormal status indicating information and the fourth type of abnormal status indicating information may also be distinguished using different icons or colors, details of which are not repeated herein.

Further, the infrared sensors are used to track the user's face through detecting infrared rays emitted by the user's body. When the user's face is located within the tracking area, but the user's face is not tracked due to another interference source, the fifth type of abnormal status indicating information is generated. The fifth type of abnormal status indicating information is used to prompt the user to remove the interference source, such that the user's face can be tracked.

Similarly, the fifth type of abnormal status indicating information may also be distinguished using different icons or colors, details of which are not repeated herein.

Optionally, to reduce power consumption, the tracking function of the 3D display apparatus may be turned off under certain circumstances (e.g., a 2D display mode). When a display mode is in a 3D display mode, the tracking function is turned on. That is, before Step 201 is performed, the process may include the step for determining the current display mode. When the current display mode is the 3D display mode, the information of the user's face is tracked. Further, after the tracking process ends and the information of the user's face is not tracked, the current 3D display mode may be switched to the 2D display mode.

By performing the above step, saving energy consumption can be achieved, thereby avoiding power consumption caused when the tracking function keeps turned on for a long time.

In another embodiment, the tracking function keeps turned on or the tracking function is turned on according to the user's instructions. After the tracking process ends, the current display mode is determined.

For example, when the information of the user's face is not tracked, if the current display mode is the 3D display mode, the current display mode is switched to the 2D display mode. If the current display mode is the 2D display mode, the current display mode remains unchanged. When the information of the user's face is tracked, if the current display mode is the 2D display mode, the current display mode is switched to the 3D display mode. If the current display mode is the 3D display mode, the current display mode is kept unchanged.

It should be noted that different abnormal status information indicating ways may be combined. Moreover, the methods in the previous embodiments can also be combined to obtain a desired status indicating information effect.

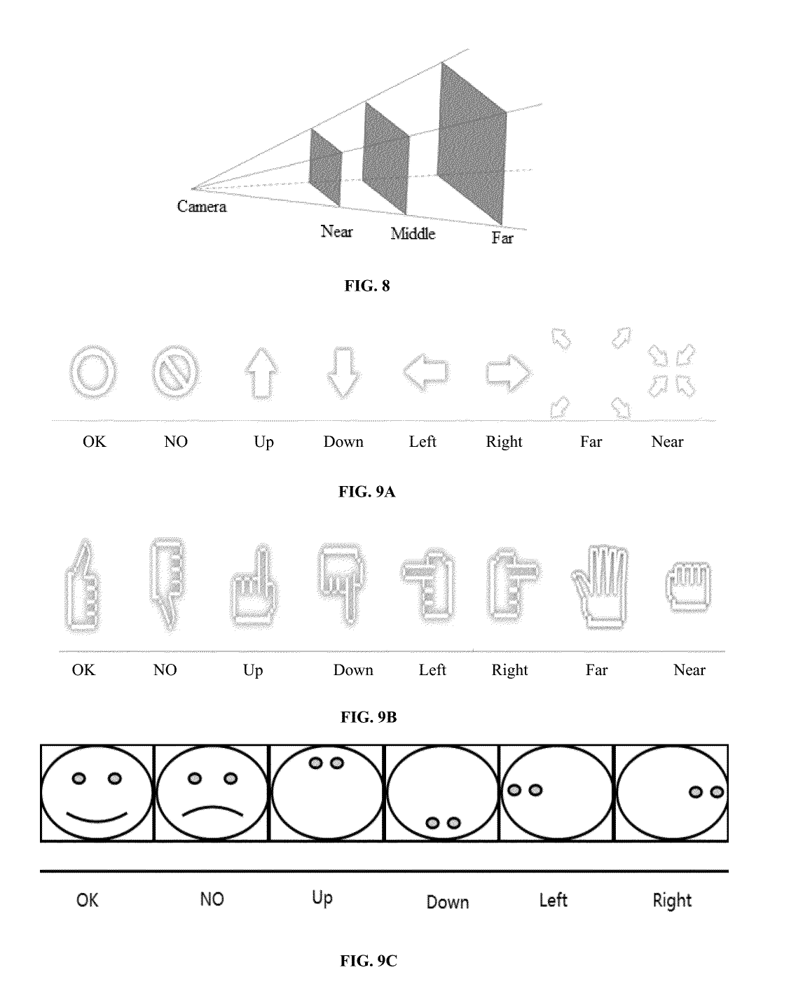

FIG. 6 illustrates a flow chart of another exemplary stereoscopic tracking status indicating process consistent with the disclosed embodiments. As shown in FIG. 6, the process may include the following steps.

Step 601: information of a user's face is tracked by a 3D display apparatus.

In Step 601, the 3D display apparatus may capture image data of the user's face through an image acquisition device, wherein the image acquisition device includes, but is not limited to, a camera. The camera may be integrated in the 3D display apparatus, and may be an external camera electrically connected to the 3D display apparatus, as long as the camera can track position information of the user relative to the 3D display apparatus. The connection between the camera and the 3D display apparatus should not be considered as limiting the scope of the disclosure.

In addition to cameras, other devices may be used to track the position of the user's face, such as infrared sensors, or ultrasonic transmitters.

Step 602: when the information of the user's face is tracked, position information of the user's face relative to the 3D display apparatus is detected.

In Step 602, after the 3D display apparatus tracks the information of the user's face, the position information of the user's face relative to the 3D display apparatus is determined using a predetermined algorithm.

Within the tracking area, the image acquisition device can detect and calculate spatial position information of the user's face relative to the 3D display apparatus. On the other hand, when the user's face is located outside the tracking area, the image acquisition device cannot detect and calculate the spatial position of the user's face relative to the 3D display apparatus.

Step 603: based on the position information, whether the user's face is located within a preset 3D display viewing area is determined. Specifically, in Step 603, based on the position information of the user's face obtained in Step 602, the 3D display apparatus determines whether the user's face is located within the preset 3D display viewing area using the related algorithm. The preset 3D display viewing area is a selected area within the tracking area. In the 3D display viewing area, the user can view the image with a desired 3D viewing effect. For example, in a display area with the desired 3D display effect, the user can obtain the desired 3D viewing effect when the user is located at any position of this display area.

Step 604: when the user's face is not in the preset 3D display viewing area, a first type of abnormal status indicating information is generated. The first type of abnormal status indicating information indicates that the user's face is located outside the preset 3D display viewing area.

In Step 604, the 3D display apparatus generates the first type of abnormal status indicating information, prompting that the user's face is not in the preset 3D display viewing area. The first type of abnormal status indicating information may be a warning tone sounded by a speaker, light emitted by an indicator light (e.g., a light emitting diode (LED) light), or a combination of one or more graphic icons.

Step 605: the first type of abnormal status indicating information is presented or transmitted to the user. The user is prompted to adjust the position of the user's face based on the first type of abnormal status indicating information, such that the user's face is located in the preset 3D display viewing area.

In Step 605, the 3D display apparatus transmits the first type of abnormal status indicating information to the user based on the manner of presenting the first type of abnormal status indicating information. For example, a corresponding warning tone is sounded in the speaker; a graph, an icon or an image is displayed at an appropriate position of the display screen of the 3D display apparatus.

After the user receives the first type of abnormal status indicating information, in order to obtain the desired 3D viewing effect, the user may adjust the position of his/her face based on the first type of abnormal status indicating information, such that the desired 3D viewing effect can be obtained.

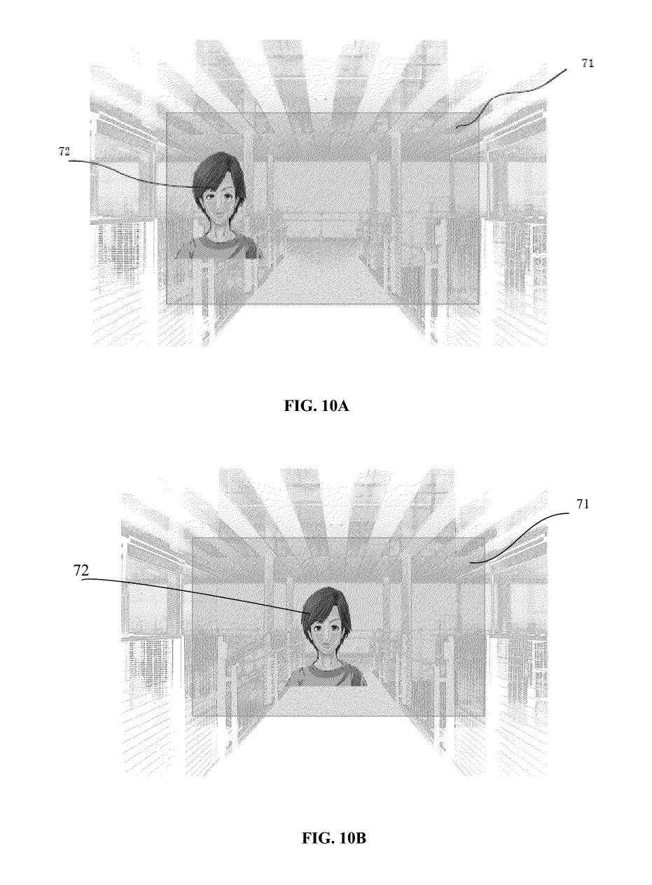

FIG. 7 illustrates a flow chart of another exemplary stereoscopic tracking status indicating process consistent with the disclosed embodiments. As shown in FIG. 7, after Step 601 is performed, the process goes to Step 610.

Step 610: whether the information of the user's face is tracked by the display apparatus is determined. If the information of the user's face is tracked, the process goes to Step 602. If the 3D display apparatus cannot track the information of the user's face (for example, when the position of the user is seriously deviated from the 3D display apparatus, the information of the user's face cannot be captured), Step 6101 is performed.

Step 6101: whether the user's face is located within the tracking area is determined. If the user's face is located within the tracking area, the process goes to Step 6102. If the user's face is not located within the tracking area, Step 608 is performed.

Step 608: when the information of the user's face is not tracked (“N”), a second type of abnormal status indicating information is generated. The second type of abnormal status indicating information indicates that the user's face is located outside the tracking area.

Step 609: the second type of abnormal status indicating information is presented or transmitted to the user, prompting that the user's face is located outside the tracking area. The user adjusts the position of the face based on the second type of abnormal status indicating information, such that the user's face is located within the tracking area.

By performing Step 608 and Step 609, it prompts the user to adjust the position of his/her face based on the second type of abnormal status indicating information, such that the user's face is located within the tracking area, bringing the desired display effect for the user. Comparing to existing technologies, the user does not need to continuously explore and judge whether his/her face is located within the tracking area, improving the user experience.

Step 6102: when the user is still within the tracking area and there is no need to adjust the position, a third type of abnormal status indicating information, a fourth type of abnormal status indicating information, or a fifth type of abnormal status indicating information may be generated according to different reasons, respectively.

Specifically, when the user's face is located within the tracking area, but the information of the user's face is not tracked because of one or more obstacles, the third type of abnormal status indicating information is generated. When the user's face is located within the tracking area, but the information of the user's face is not tracked because light intensity exceeds a threshold, the fourth type of abnormal status indicating information is generated. When the user's face is located within the tracking area, but the user's face is not tracked because of another interference source, the fifth type of abnormal status indicating information is generated.

Through the third type of abnormal status indicating information, the fourth type of abnormal status indicating information and the fifth type of abnormal status indicating information, the user knows that he/she is still within the tracking area and there is no need to adjust the position. However, the user needs to check reasons causing the situation, such that the user's face can be tracked. Therefore, the user's experience is improved.

Further, when the information of the user's face is tracked (“Y”), the process goes to Step 602.

Step 602: the position information of the user's face relative to the 3D display apparatus is determined

Step 6031: whether the user's face is located within a preset 3D display viewing area is determined.

Specifically, based on the position information of the user's face obtained in Step 602, the 3D display apparatus determines whether the user's face is located within the preset 3D display viewing area. The preset 3D display viewing area is a selected area within the tracking area. In the 3D display viewing area, the user can view the image with a desired 3D viewing effect.

Further, after Step 6031 is performed, the process may further include Step 606 and Step 607, or Step 604 and Step 605.

Step 606: when the user's face is located in the preset 3D display viewing area (“Y”), normal status indicating information is generated. The normal status indicating information indicates that the user's face is located in the preset 3D display viewing area.

In Step 606, the normal status indicating information may be a combination of one or more graphic icons, sound and indicator light. It should be noted that the normal status indicating information needs to be distinguished from the abnormal status indicating information.

Step 607: the normal status indicating information is presented or transmitted to the user, prompting that the user's face is in the preset 3D display viewing area.

In Step 607, similar to the embodiments described with FIG. 6, after the normal status indicating information is generated, the 3D display apparatus transmits the normal status indicating information to the user. For example, a graph, an icon or an image may be displayed on the display screen of the 3D display apparatus; a corresponding tone is sounded in the speaker; or light is emitted by the indicator light.

The normal status indicating information is used to prompt the user that the user is in the preset 3D display viewing area, and the user can obtain the desired 3D viewing effect when the current status is kept unchanged.

For example, after the second type of abnormal status indicating information is generated, the 3D display apparatus needs to transmit the second type of abnormal status indicating information to the user, such as displaying a graphic icon through the display screen, emitting light by an LED light, or sounding warning tone by a speaker.

In Step 6031, when the 3D display apparatus determines whether the user's face is located within the preset 3D display viewing area based on the position information, the preset 3D display viewing area is a desired 3D display viewing area. When the image acquisition device is integrated in the 3D display apparatus, the preset 3D display viewing area can be delimited according to some parameters, such as a viewing angle of the image acquisition device (e.g., a viewing angle of a camera the image acquisition device of approximately 30 to 60 degrees is used), and a distance from the image acquisition device. In general, the desired 3D display viewing area is in the space between the first section and the second section formed when the vertical edge is tangent to the vertical plane in the space delimited based on the viewing angle of the image acquisition device. For example, a viewing perspective is inclined to the normal of the display surface through an angle similar to an angle at which the camera perspectives are inclined to the normal of the base plane. The inclination angle of the camera and viewing perspectives is around 45 degrees so that variations in object elevation and near-to-far position have substantially equal ranges within the display.

The desired 3D display viewing area is related to the screen size of the 3D display apparatus, the installation position of the image acquisition device, and so on. If these related factors are different, the delimited desired 3D display viewing area is different. For example, because the related factors of a smartphone and a laptop are different, the desired 3D display viewing area of the smartphone and the desired 3D display viewing area of the laptop are different. In addition, for a same display apparatus, if the image acquisition device is installed at the edge or in the middle top of the screen, the corresponding desired 3D display viewing areas are different.

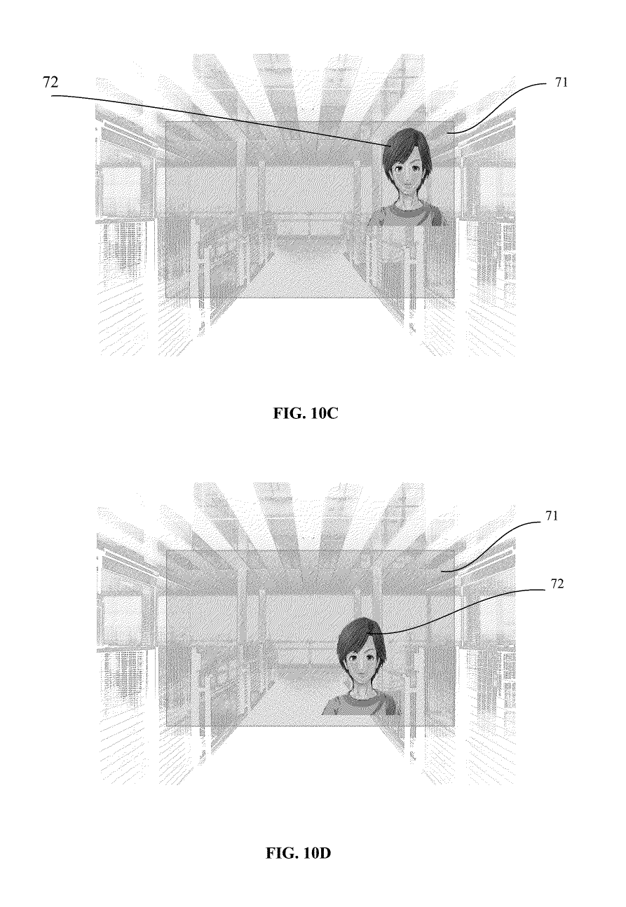

FIG. 8 illustrates a schematic diagram of an exemplary method for setting a 3D display viewing area in a stereoscopic tracking status indicating process consistent with the disclosed embodiments. As shown in FIG. 8, a camera is installed on the middle top of the display apparatus with a 21-inch screen. The desired 3D display viewing area can be delimited based on the following parameters: the space between a front clipping plane which is 0.2 meters from the camera and a back clipping plane which is 1 meter from the camera; the maximum right deflection and left deflection of the camera are 40 degree, respectively; the maximum upper deflection of the camera is 30 degree; and the maximum lower deflection of the camera is 50 degree. Such 3D display viewing area can be delimited through experiments or related algorithms.

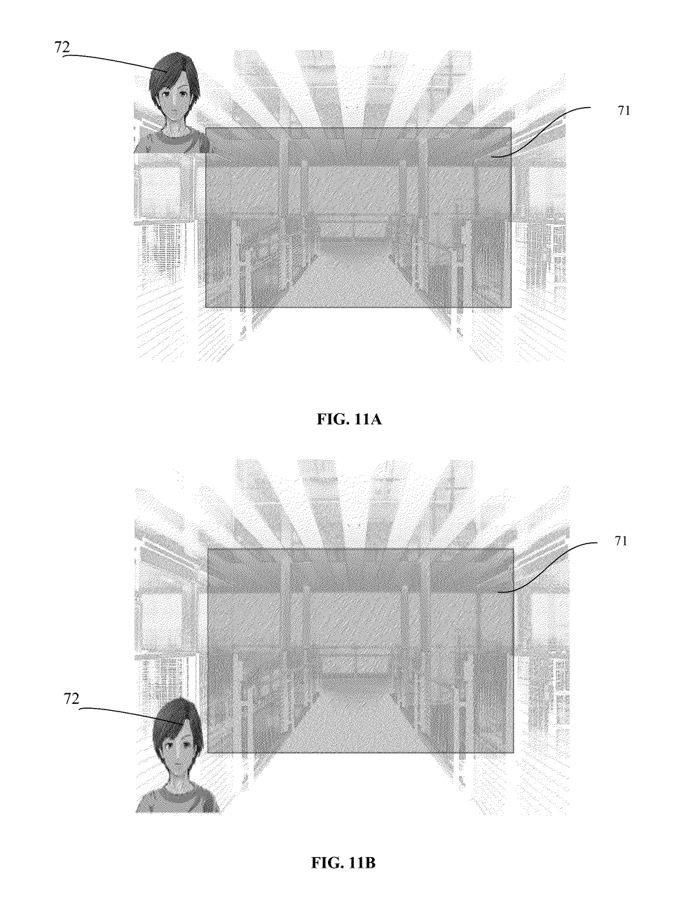

FIGS. 9A to 9C illustrate schematic diagrams of exemplary abnormal and normal status indicating information consistent with the disclosed embodiments. As shown in FIG. 9A to FIG. 9C, the first type of abnormal status indicating information, the second type of abnormal status indicating information and the normal status indicating information generated by the display apparatus are graphic icons. Based on different applications, different icons may be selected, such as, direction icons in FIG. 9A, gesture icons in FIG. 9B, and face icons in FIG. 9C. Optionally, pictures, photos and text can also be selected as indicating information.

In FIG. 9A, the first icon (“O”) may represent the normal status indicating information, which means that the user may have a desired 3D viewing experience when keeping the current position, i.e., the user's face is located within the preset 3D display viewing area. Other icons indicate that the user's face is not located within the preset 3D display viewing area, for example, the icon may represent the first type of abnormal status indicating information which means that the user is located within the 3D display viewing area, but not the desired 3D display viewing area; the icon may also represent the second type of abnormal status indicating information which means that the user is located outside the tracking area. For another example, the second icon (“ [symbol] ”) in FIG. 9A represents that the user's face is located outside the preset 3D display viewing area or outside the tracking area; the third icon (“arrow up”) represents that the position of the user's face is a little bit lower, and the user's face needs to be moved up to be in the preset 3D display viewing area; similarly, the fourth icon (“arrow down”), the fifth icon (“arrow left”) and the sixth icon (“arrow right”) represent respectively that the user can move down, to the left and to the right, such that the position of the face is adjusted to the preset 3D display viewing area; the seventh icon (“ [symbol] ”) represents that the distance between the user and the 3D display apparatus is too close, and the user needs to get away from the display apparatus, such that the position of the face is adjusted to the preset 3D display viewing area; and the corresponding eighth icon (“ [symbol] ”) represents that the distance between the user and the 3D display apparatus is too far, and the user needs to move closer to the 3D display apparatus, such that the position of the face is adjusted to the preset 3D display viewing area.

In FIG. 9B, the first gesture icon (“thumb up”) may represent the normal status indicating information, which means that the user may have a desired 3D viewing experience when keeping the current position, i.e., the user's face is located within the preset 3D display viewing area. Other gesture icons indicate that the user's face is not located in the preset 3D display viewing area, for example, the gesture icon may represent the first type of abnormal status indicating information which means that the user is located in the 3D display viewing area, but not the desired 3D display viewing area; the gesture icon may also represent the second type of abnormal status indicating information which means that the user is located outside the tracking area. For another example, the second gesture icon (“thump down”) in FIG. 9B represents that the user's face is located outside the preset 3D display viewing area or outside the tracking area; the third gesture icon (“index finger up”) represents that the position of the user's face is a little bit lower, and the user's face needs to be moved up to be in the preset 3D display viewing area; similarly, the fourth gesture icon (“index finger down:), the fifth gesture icon (“index finger left”) and the sixth gesture icon (“index finger right”) represent respectively that the user can move down, to the left and to the right, such that the position of the face is adjusted to the preset 3D display viewing area; the seventh gesture icon (“hand showing five count”) represents that the distance between the user and the 3D display apparatus is too close, and the user needs to get away from the display apparatus, such that the position of the face is adjusted to the preset 3D display viewing area; and the corresponding eighth gesture icon (“fist”) represents that the distance between the user and the 3D display apparatus is too far, and the user needs to move closer to the 3D display apparatus, such that the position of the face is adjusted to the preset 3D display viewing area.

In FIG. 9C, the first face icon (“smiley face”) may represent the normal status indicating information, which means that the user may have a desired 3D viewing experience when keeping the current position, i.e., the user's face is located within the preset 3D display viewing area. The second face icon (“sad face”) represents that the user's face is located outside the preset 3D display viewing area, or outside the tracking area. The third face icon (“face look up”) represents that the position of the user's face is a little bit lower, and the user's face needs to be moved up, such that the position of the face is adjusted to the preset 3D display viewing area. Similarly, the fourth face icon (“face look down”), the fifth face icon (“face look left”) and the sixth face icon (“face look right”) represent respectively that the user can move down, to the left and to the right, such that the position of the face is adjusted to the preset 3D display viewing area, which are not repeated herein.

Of course, any status indicated through icons shown in FIGS. 9A to 9C is only illustrative. In practical applications, the status can be displayed through combining the icons with different colors or combining the icons with text, such as a text prompt and an icon prompt manner.

It should be noted that the display position of every icon shown in FIGS. 9A to 9C may be set at any position of the display screen of the display apparatus, but the display position of the icon should not affect the user to view the image data.

Thus, the 3D display apparatus can determine whether the user is located within the desired 3D display viewing area based on position information of the user's face. Then, the 3D display apparatus transmits the normal or abnormal status indicating information to the user using the icons, prompting the user to adjust his/her face position and obtaining the desired 3D viewing effect.

Optionally, the 3D display apparatus may set an area for displaying an operating scene on the display interface of the screen. The area for displaying the operating scene includes two display parts: a simulating user area which includes the user's face and a simulating preset 3D display viewing area. The simulating user area is used to simulate the user using an image mode and simulation tracking is performed through the user's image obtained by the image acquisition device (e.g., a camera). The simulating preset 3D display viewing area is used to simulate the preset 3D display viewing area using the image mode and it can be determined using a predetermined algorithm based on the images obtained by the image acquisition device.

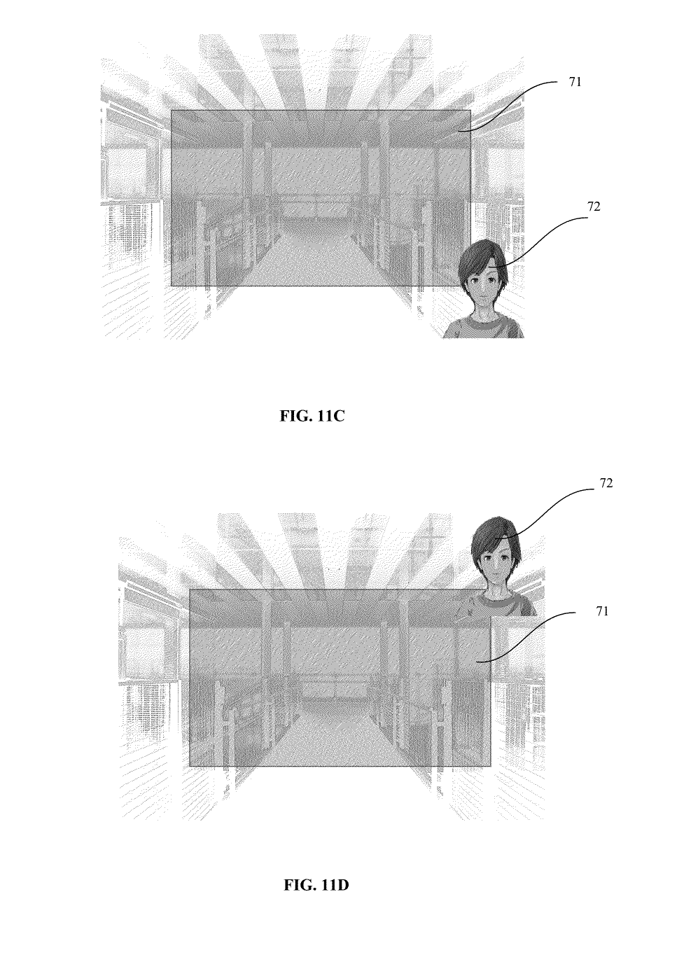

FIGS. 10A to 10D illustrate schematic diagrams of exemplary implementing process for displaying normal status indicating information consistent with the disclosed embodiments. As shown in FIGS. 10A to 10D, when the user's face is located within the preset 3D display viewing area, a simulating preset 3D display viewing area 71 in the display interface appears with a first visual effect, such as a first color (including, but is not limited to green, yellow, and so on); the contour line of the user's face is displayed in the simulating user area 72, where the color of the contour line can be yellow, blue, and so on (as long as there is color difference with the first visual effect). At this point, normal status indicating information is displayed to the user, prompting the user to keep the current position to obtain the desired 3D display viewing effect. As shown in FIG. 10A, the simulating user area 72 is located in the left part of the simulating preset 3D display viewing area 71. As shown in FIG. 10B, the simulating user area 72 is located in the middle of the simulating preset 3D display viewing area 71. As shown in FIG. 10C, the simulating user area 72 is located in the upper right part of the simulating preset 3D display viewing area 71. As shown in FIG. 10D, the simulating user area 72 is located in the lower right part of the simulating preset 3D display viewing area 71.

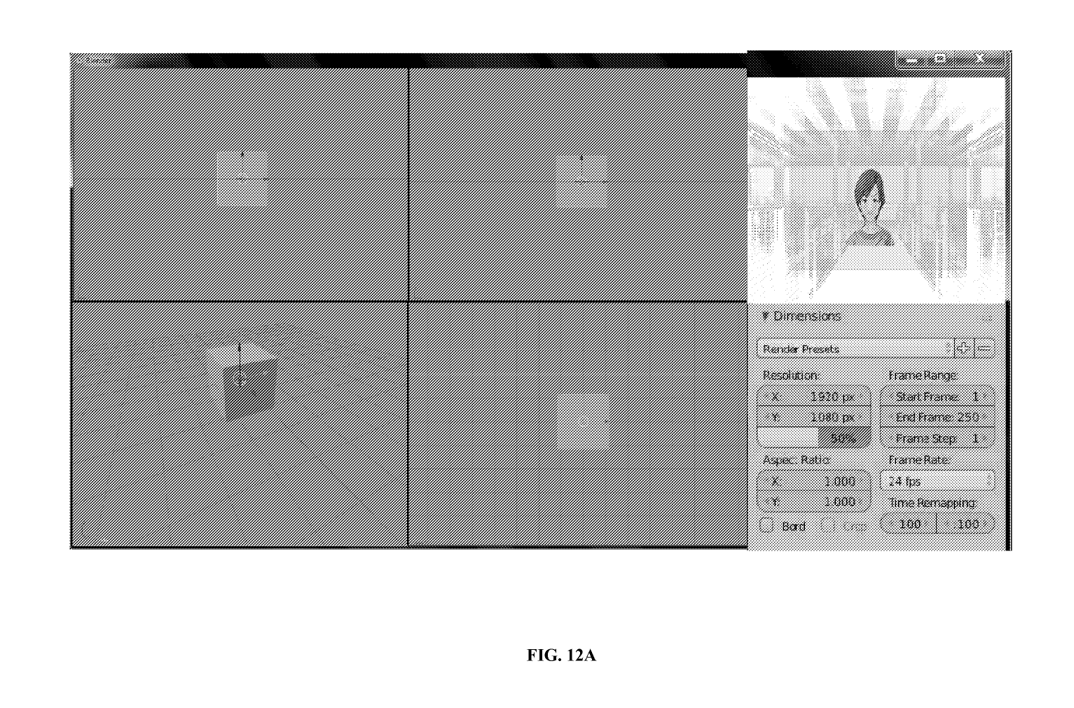

Accordingly, FIGS. 11A to 11D illustrate schematic diagrams of exemplary implementing process for displaying abnormal status indicating information consistent with the disclosed embodiments. As shown in FIGS. 11A to 11D, when a user's face is located outside the preset 3D display viewing area, the simulating preset 3D display viewing area 71 in the display interface appears with a second visual effect with a warning effect, such as a second color (including, but is not limited to red, yellow, and so on); the contour line of the user's face is not displayed in the simulating user area. At this point, the abnormal status indicating information is displayed to the user, prompting the user to adjust his/her position to obtain the desired 3D display viewing effect. As shown in FIG. 11A, the simulating user area 72 is located at the upper left side of the simulating preset 3D display viewing area 71. As shown in FIG. 11B, the simulating user area 72 is located as the lower left side of the simulating preset 3D display viewing area 71. As shown in FIG. 11C, the simulating user area 72 is located at the lower right side of the simulating preset 3D display viewing area 71. As shown in FIG. 11D, the simulating user area 72 is located at the upper right side of the simulating preset 3D display viewing area 71.

In addition, the 3D display apparatus may also adjust display status of the simulating preset 3D display viewing area and the simulating user area according to actual needs. For example, when the user's face is about to deviate from the preset 3D display viewing area, the simulating preset 3D display viewing area 71 in the display interface appears with a third visual effect, such as a third color; or the contour line of the user's face starts flashing in the simulating user area 72, thereby prompting the user not to deviate from the preset 3D display viewing area.

It should be noted that the combination of the simulating 3D display viewing area and the simulating user area is only illustrative, and it should not be understood as limitation of this disclosure. In specific applications, the simulating preset 3D display viewing area and the simulating user area can be adjusted according to actual needs, for example, only the simulating preset 3D display viewing area is displayed, or only the simulating user area is displayed, or combinations with any other implementing mode.

The above embodiment is suitable for the scene that the user edits 3D images through the 3D display interface of the display apparatus. In a scene that the user edits 3D images and designs a 3D model using a 3D content interactive mode, the user not only focuses on the 3D content, but also needs to control the overall situation. The interactive user interface is used to explore and discover information which has been attached to objects. For example, the 3D display user interface of the display apparatus can be an aid to understanding the complex structure of an object and provide viewpoints or cross sections which are difficult or impossible to see.

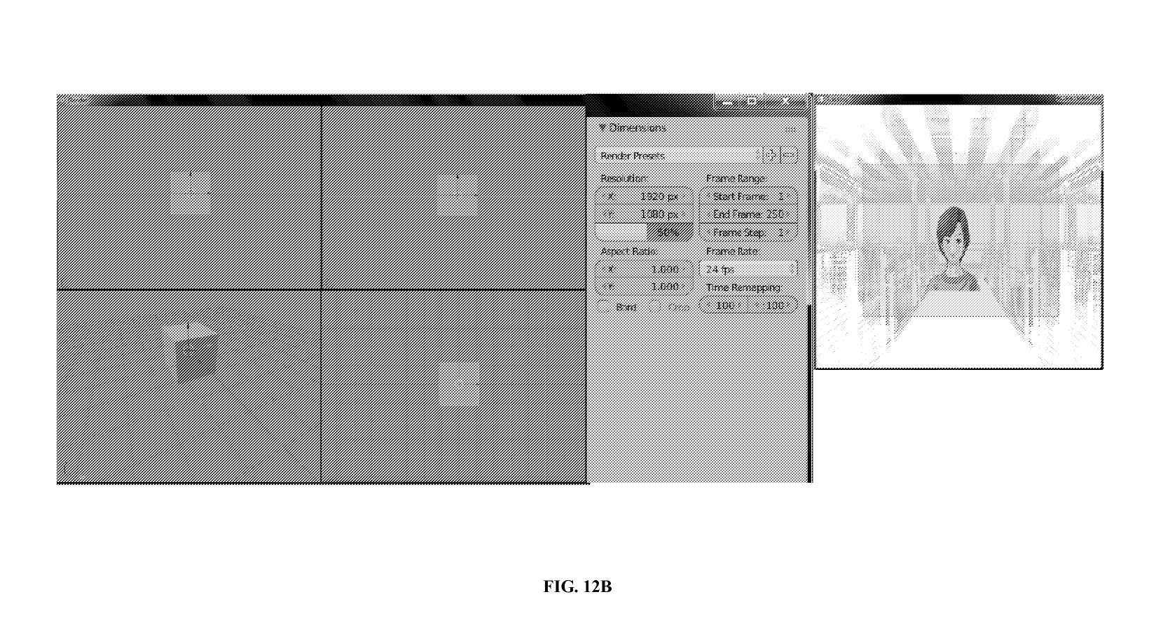

FIG. 12A illustrates a schematic diagram of an exemplary way for displaying status indicating information consistent with the disclosed embodiments. As shown in FIG. 12A, when a user runs a 3D image processing program through a 3D display apparatus in a full screen mode, a view window for displaying a schematic area of operating scene can be dragged and zoomed. The style of the view window is the same as the style of any other view window in the program processing interface, and position and size of the view window can be set by the user. The size of the view window is related to the size of the display screen of the display apparatus. Because the display screen affects the appropriate viewing distance of the user, the appropriate selection of view window allows the user to clearly distinguish the status of an indicating sign within appropriate viewing distance.

In addition, the corresponding software can be configured in the display apparatus. When the 3D image processing program runs in a window mode, the view window for displaying schematic area of operating scene can be dragged outside the window for displaying the 3D image processing program, forming an independent view. Therefore, the editing space is saved. As shown in FIG. 12B, the view window is located at the right edge of the window for displaying the 3D image processing program. As shown in FIG. 12C, the view window is an independent window located at the right side of the window for displaying the 3D image processing program.

Therefore, when the user edits the 3D image through the 3D display apparatus, the user can track position information of the user's face. Therefore, the user can obtain a desired viewing effect to edit more accurate 3D image.

Optionally, the display apparatus may transmit the normal status indicating information, the first type of abnormal status indicating information, or the second type of abnormal status indicating information to the user through a built-in speaker or an external speaker. The speaker can broadcast the status indicating information to the user. For example, when the user's face is located below the preset 3D display viewing area, the speaker broadcasts “please move up” or “up” to prompt the user; when the user's face is located above the preset 3D display viewing area, the speaker broadcasts “please move down” or “down” to prompt the user; when the user's face is located with the preset 3D display viewing area, the speaker broadcasts “OK” to prompt the user. This mode can directly prompt the user to adjust his/her position without the need of second judgment, thereby improving the user experience.

Optionally, the display apparatus may transmit the normal status indicating information, the first type of abnormal status indicating information, or the second type of abnormal status indicating information to the user through a built-in LED light or an external LED light. The LED light can be used to transmit the status indicating information to the user. The LED light may flash different colors to represent normal or abnormal status indicating information. For example, when the user's face is located below the preset 3D display viewing area, the yellow indicator light may be flashed to prompt the user to adjust the position.

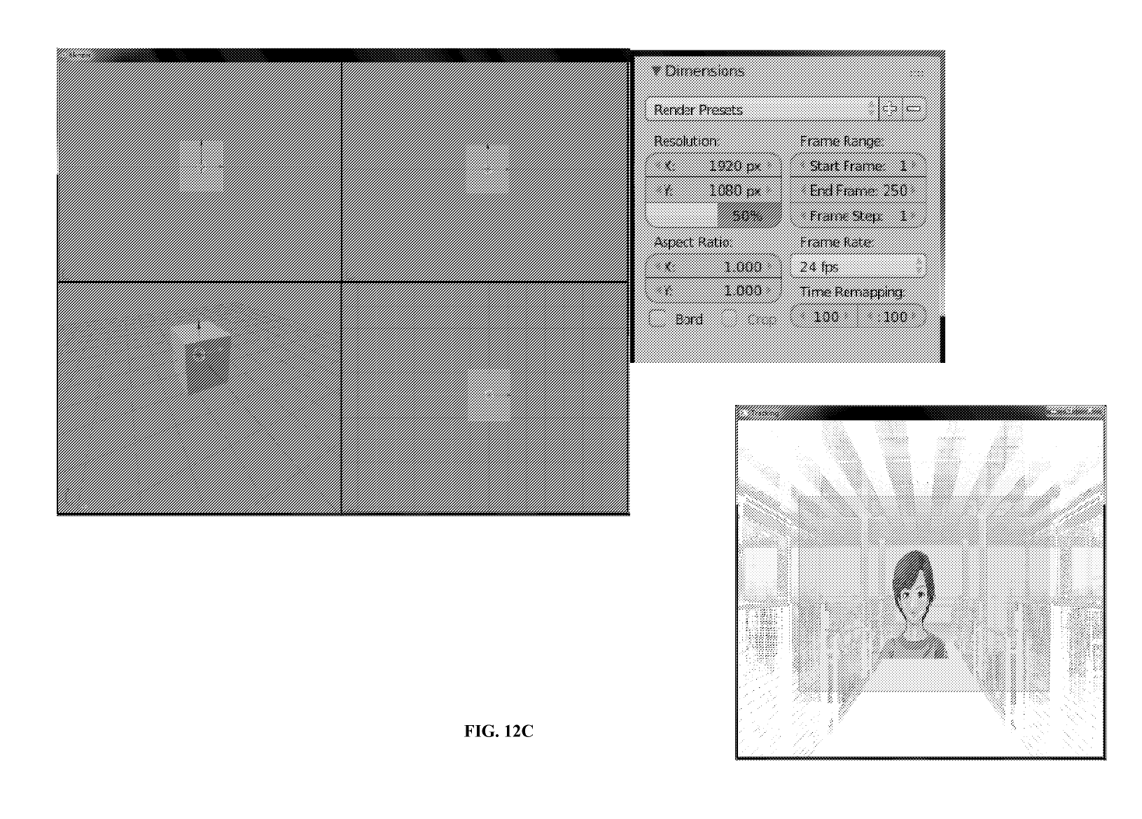

FIG. 13 illustrates a structure diagram of an exemplary display apparatus consistent with the disclosed embodiments. The display apparatus may include, but is not limited to, any display apparatus with a 3D display function, such as a smartphone, a computer monitor, a liquid crystal display (LCD) TV, a personal computer (PC), a tablet PC, and a game machine. As shown in FIG. 13, the display apparatus 1300 may include a tracking unit 1301, an abnormal information generation unit 1302, and an information transmission unit 1303.

The tracking unit 1301 may be configured to track information of a user's face. The abnormal information generation unit 1302 may be configured to, when the information of the user's face is not tracked, generate abnormal status indicating information, where the abnormal status indicating information indicates that the information of the user's face is not tracked.

The information transmission unit 1303 may be configured to transmit the abnormal status indicating information to the user. The information transmission unit 1303 may transmit the abnormal indicating information to the user through icons, an LED indicator light or a speaker.

Optionally, when the user's face is located outside the tracking area and the information of the user's face is not tracked, the second type of abnormal status indicating information may be generated as the abnormal status indicating information. The second type of abnormal status indicating information indicates that the user's face is located outside the tracking area, prompting the user to adjust the position based on the second type of abnormal status indicating information.

Optionally, when the user's face is located within the tracking area, but the information of the user's face is not tracked, the third type of abnormal status indicating information, the fourth type of abnormal status indicating information, and the fifth type of abnormal status indicating information may be generated as the abnormal status indicating information.

Optionally, the tracking unit 1301 may be configured to track the information of the user's face using an image acquisition device. When the user's face is located within the tracking area, but the information of the user's face is not tracked because of one or more obstacles, the third type of abnormal status indicating information is generated. The third type of abnormal status indicating information is used to prompt the user to remove the obstacle, such that the information of the user's face can be tracked. When the user's face is located within the tracking area, but the information of the user's face cannot be tracked because the light intensity exceeds a threshold, the fourth type of abnormal status indicating information is generated. The fourth type of abnormal status indicating information is used to prompt the user to adjust the light intensity, such that the user's face can be tracked.

Optionally, the tracking unit 1301 may be configured to track the information of the user's face using infrared sensors. When the user's face is located within the tracking area, but the information of the user's face is not tracked due to an interference source, the fifth type of abnormal status indicating information is generated. The fifth type of abnormal status indicating information is used to prompt the user to remove the interference source, such that the information of the user's face can be tracked.

Optionally, the tracking unit 1301 may be configured to emit ultrasonic wave through ultrasonic transmitters, and track the information of the user's face through parameters of the received ultrasonic wave.

The abnormal status indicating information may include at least one type of direction icons, gesture icons, face icons, color icons, images and text. Or, the abnormal status indicating information may include at least one type of indicator lights, warning tones and graphic icons.

Optionally, the 3D display apparatus 1300 may also include a normal information generation unit. The normal information generation unit is configured to, when the user's face is tracked, generate normal status indicating information. The normal status indicating information indicates that the information of the user's face is tracked.

The information transmission unit 1303 may be also configured to transmit the normal status indicating information to the user.

Optionally, the display apparatus may also include a display mode determination unit and a display mode switching unit. The display mode determination unit may be configured to determine a current display mode. The display mode switching unit may be configured to switch between a 2D display mode and a 3D display mode.

For example, when the display determination unit determines that the current display mode is the 3D display mode, the tracking unit is informed to track the information of the user's face. Then, when the information of the user's face is not tracked, the display mode switching unit switches the 3D display mode to the 2D display mode.

Optionally, when the information of the user's face cannot be tracked, the display mode determination unit determines the current display mode. When it is determined that the current display mode is the 3D display mode, the display mode switching unit switches the current 3D display mode to the 2D display mode. When it is determined that the current display mode is the 2D display mode, the current 2D display mode is kept unchanged.

When the information of the user's face can be tracked, the display mode determination unit determines the current display mode. When it is determined that the current display mode is the 2D display mode, the display mode switching unit switches the current 2D display mode to the 3D display mode. When it is determined that the current display mode is the 3D display mode, the current 3D display mode is kept unchanged.

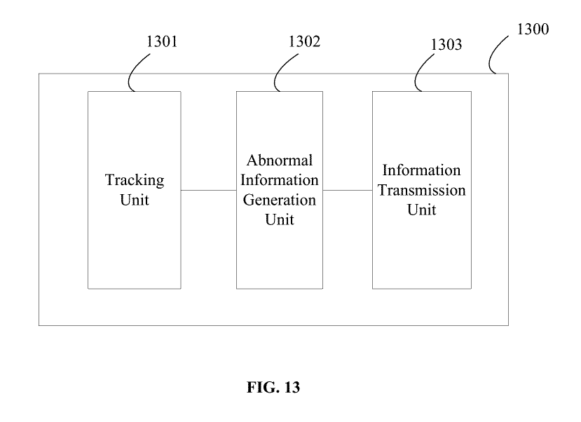

FIG. 14 illustrates a structure diagram of an exemplary display apparatus consistent with the disclosed embodiments. The display apparatus may include, but is not limited to, any display apparatus with a 3D display function, such as a smartphone, a computer monitor, a liquid crystal display (LCD) TV, a personal computer (PC), a tablet PC, and a game machine. As shown in FIG. 14, the display apparatus 1400 may include a tracking unit 1401, a detecting unit 1402, a determination unit 1403, a first abnormal information generation unit 1404, and an information transmission unit 1405.

The tracking unit 1401 may be configured to track information of a user's face.

The detecting unit 1402 may be configured to, when the information of the user's face is tracked by the tracking unit 1401, detect position information of the user's face relative to the 3D display apparatus.

The determination unit 1403 may be configured to, based on the position information of the user's face, determine whether the user's face is located within a preset 3D display viewing area.

The first abnormal information generation unit 1404 may be configured to, when the user's face is not located within the preset 3D display viewing area, generate a first type of abnormal status indicating information, where the first type of abnormal status indicating information indicates that the user's face is located outside the preset 3D display viewing area.

The information transmission unit 1405 may be configured to transmit the first type of abnormal status indicating information to the user, prompting the user to adjust the position of the user's face based on the first type of abnormal status indicating information, such that the user's face is within the preset 3D display viewing area.

Optionally, the 3D display apparatus 1400 may also include a normal information generation unit. The normal information generation unit may be configured to, when the user's face is located within the preset 3D display viewing area, generate normal status indicating information, where the normal status indicating information indicates that the user's face is located within the preset 3D display viewing area.

The information transmission unit 1405 may be also configured to transmit the normal status indicating information to the user, prompting the user that the user is in the preset 3D display viewing area.

Optionally, the display apparatus 1400 may also include a second abnormal information generation unit.

The second abnormal information generation unit may be configured to, when the information of the user's face is not tracked by the tracking unit 1401, generate a second type of abnormal status indicating information, where the second type of abnormal status indicating information indicates that the user's face is located outside the tracking area.

The information transmission unit 1405 may be also configured to transmit the second type of abnormal status indicating information to the user, prompting the user to adjust the position of the user's face based on the second type of abnormal status indicating information, such that the user's face is within the tracking area.

Further, the detecting unit 1402 may also include a capture subunit and a calculation subunit.

The capture subunit may be configured to capture an image of the user's face through an image acquisition device. The calculation subunit may be configured to calculate the position information of the user's face relative to the 3D display apparatus based on the image of the user's face.

The first type of abnormal status indicating information and the second type of abnormal status indicating information may include at least one type of direction icons, gesture icons, face icons and color icons, which can be set through the software. The specific description can refer to FIG. 6 and FIG. 7, which is not repeated herein.

The first type of abnormal status indicating information and the second type of abnormal status indicating information may also include one type of indicator light, warning tone and icon, which can be set through the software. The specific description can refer to FIG. 6 and FIG. 7, which is not repeated herein.

In general, the 3D display viewing area is in the space between the first section and the second section in the space delimited based on a viewing angle of the image acquisition device. The preset 3D display viewing area is the desired 3D display viewing area. The desired 3D display viewing area can be delimited based on the viewing angle of the image acquisition device.

The first type of abnormal status indicating information is displayed through the simulating user area and the simulating preset 3D display viewing area, which is similar to the previous embodiments described with FIG. 11A to 11D. The simulating user area is used to simulate the user using an image mode. The simulating preset 3D display viewing area is used to simulate the preset 3D display viewing area using the image mode. The specific description can refer to FIGS. 11A to 11D, details of which are not repeated herein.

Through the 3D display apparatus provided in this disclosure, position information of the user's face relative to the 3D display apparatus is detected by the image acquisition device associated with the 3D display apparatus. Based on the position information, whether the user's face is located in the preset 3D display viewing area is determined. When the user's face is not located in the preset 3D display viewing area, the abnormal status indicating information is generated and transmitted to the user, thereby prompting the user to adjust the position of his/her face based on the abnormal status indicating information. Therefore, the position of the user's face is located in the preset 3D display viewing area, and the user can obtain a desired 3D viewing effect.

Further, although the methods and apparatuses are disclosed for illustrative purposes, similar concept and approach can be applied to other display apparatus. Other applications, advantages, alternations, modifications, or equivalents to the disclosed embodiments are obvious to those skilled in the art.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

Through a 3D display apparatus provided in this disclosure, position information of a user's face relative to the 3D display apparatus is detected by an image acquisition device associated with the 3D display apparatus. Based on the position information of the user's face, whether the user's face is located in a preset 3D display viewing area is determined. When the user's face is not located in the preset 3D display viewing area, abnormal status indicating information is generated and transmitted to the user, thereby prompting the user to adjust the position of his/her face based on the abnormal status indicating information. Therefore, the position of the user's face is located in the preset 3D display viewing area, and the user can obtain a desired 3D viewing effect.

What is claimed is:

1. A stereoscopic tracking status indicating method, comprising:
tracking information of a user's face by a three-dimensional (3D) display apparatus;
when the information of the user's face is not tracked, generating abnormal status indicating information, wherein the abnormal status indicating information indicates that the information of the user's face is not tracked; and
presenting the abnormal status indicating information to the user, such that the user is prompted to adjust a position of the user's face based on the abnormal status indicating information.

2. The method according to claim 1, further including:
when the information of the user's face is tracked, detecting position information of the user's face relative to the 3D display apparatus;
based on the position information of the user's face, determining whether the user's face is located within a preset 3D display viewing area;
when the user's face is not located within the preset 3D display viewing area, generating a first type of abnormal status indicating information, wherein the first type of abnormal status indicating information indicates that the user's face is located outside the preset 3D display viewing area; and
presenting the first type of abnormal status indicating information to the user, such that the user is prompted to adjust the position of the user's face to the preset 3D display viewing area based on the first type of abnormal status indicating information.

3. The method according to claim 2, further including:
when the user's face is located within the preset 3D display viewing area, generating normal status indicating information, wherein the normal status indicating information indicates that the user's face is located within the preset 3D display viewing area; and
presenting the normal status indicating information to the user, such that the user is prompted that the user is located within the preset 3D display viewing area.

4. The method according to claim 2, further including:
when the user's face is located outside a tracking area and the user's face is not tracked, generating a second type of abnormal status indicating information, wherein the second type of abnormal status indicating information indicates that the user's face is located outside the tracking area; and
presenting the second type of abnormal status indicating information to the user, such that the user is prompted to adjust the position of the user's face to the tracking area based on the second type of abnormal status indicating information.

5. The method according to claim 2, further including:
when the user's face is located within the tracking area, but the information of the user's face is not tracked because of one or more obstacles, generating a third type of abnormal status indicating information;
when the user's face is located within the tracking area, but the information of the user's face is not tracked because light intensity exceeds a threshold, generating a fourth type of abnormal status indicating information; and
when the user's face is located within the tracking area, but the user's face is not tracked because of another interference source, generating a fifth type of abnormal status indicating information.

6. The method according to claim 2, wherein when the information of the user's face is tracked, detecting position information of the user's face relative to the 3D display apparatus further includes:
capturing an image of the user's face using an image acquisition device; and
based on the image of the user's face, calculating the position information of the user's face relative to the 3D display apparatus.

7. The method according to claim 4, wherein:
the first type of abnormal status indicating information, the second type of abnormal status indicating information, the third type of abnormal status indicating information, the fourth type of abnormal status indicating information, and the fifth type of abnormal status indicating information include at least one type of indicator lights, warning tones and graphic icons.

8. The method according to claim 6, wherein:
the preset 3D display viewing area is a desired 3D display viewing area delimited based on a viewing angle of the image acquisition device; and
the desired 3D display viewing area is in space between a first section and a second section, wherein the first section and the second section are formed when a vertical edge is tangent to a vertical plane in space delimited based on the viewing angle of the image acquisition device.

9. The method according to claim 2, wherein:
the first type of abnormal status indicating information is displayed through a simulating user area and a simulating preset 3D display viewing area;
the simulating user area is used to simulate a user area using an image mode; and
the simulating preset 3D display viewing area is used to simulate the preset 3D display viewing area using the image mode.

10. The method according to claim 4, wherein:
the first type of abnormal status indicating information, the second type of abnormal status indicating information, the third type of abnormal status indicating information, the fourth type of abnormal status indicating information, and the fifth type of abnormal status indicating information include at least one type of direction icons, gesture icons, face icons, color icons, images and text.

11. The method according to claim 1, wherein:
when a current display mode is in a 3D display mode, the 3D display apparatus tracks the information of the user's face; and
when the information of the user's face is not tracked, the 3D display mode is switched to a two-dimensional (2D) display mode.

12. A display apparatus to display a three-dimensional (3D) image, comprising:
a tracking unit configured to track information of a user's face;
an abnormal information generation unit configured to, when the information of the user's face is not tracked, generate abnormal status indicating information, wherein the abnormal status indicating information indicates that the information of the user's face is not tracked; and
an information transmission unit configured to transmit the abnormal status indicating information to the user, such that the user is prompted to adjust a position of the user's face based on the abnormal status indicating information.

13. The apparatus according to claim 12, further including:
a detecting unit configured to, when the information of the user's face is tracked by the tracking unit, detect position information of the user's face relative to the display apparatus;
a determination unit configured to determine whether the user's face is located within a preset 3D display viewing area based on the position information of the user's face;
a first abnormal information generation unit configured to, when the user's face is not located in the preset 3D display viewing area, generate a first type of abnormal status indicating information, wherein the first type of abnormal status indicating information indicates that the user's face is located outside the preset 3D display viewing area;
a normal information generation unit configured to, when the user's face is located within the preset 3D display viewing area, generate normal status indicating information, wherein the normal status indicating information indicates that the user's face is located within the preset 3D display viewing area; and
the information transmission unit further configured to:
when the first type of abnormal status indicating information is generated, transmit the first type of abnormal status indicating information to the user, such that the user is prompted to adjust the position of the user's face to the preset 3D display viewing area based on the first type of abnormal status indicating information; and
when the normal status indicating information is generated, transmit the normal status indicating information to the user, such that the user is prompted that the user is located within the preset 3D display viewing area.

14. The apparatus according to claim 13, further including:
a second abnormal information generation unit configured to, when the user's face is located outside a tracking area and the information of the user's face is not tracked, generate a second type of abnormal status indicating information, wherein the second type of abnormal status indicating information indicates that the user's face is located outside the tracking area; and
the information transmission unit further configured to transmit the second type of abnormal status indicating information to the user, such that the user is prompted to adjust the position of the user's face to the tracking area based on the second type of abnormal status indicating information.

15. The apparatus according to claim 12, wherein:
when the user's face is located within the tracking area, but the information of the user's face is not tracked because of one or more obstacles, a third type of abnormal status indicating information is generated;
when the user's face is located within the tracking area, but the information of the user's face is not tracked because light intensity exceeds a threshold, a fourth type of abnormal status indicating information is generated; and
when the user's face is located within the tracking area, but the user's face is not tracked because of another interference source, a fifth type of abnormal status indicating information is generated.

16. The apparatus according to claim 12, wherein the detecting unit further includes:
a capture subunit configured to capture an image of the user's face through an image acquisition device; and
a calculation subunit configured to calculate the position information of the user's face relative to the display apparatus based on the image of the user's face.

17. The apparatus according to claim 14, wherein:
the preset 3D display viewing area is a desired 3D display viewing area delimited based on a viewing angle of the image acquisition device;
the desired 3D display viewing area is in space between a first section and a second section, wherein the first section and the second section are formed when a vertical edge is tangent to a vertical plane in space delimited based on the viewing angle of the image acquisition device;
the first type of abnormal status indicating information is displayed through a simulating user area and a simulating preset 3D display viewing area, wherein the simulating user area is used to simulate a user area using an image mode, and the simulating preset 3D display viewing area is used to simulate the preset 3D display viewing area using the image mode.

18. The apparatus according to claim 14, wherein:
the first type of abnormal status indicating information, the second type of abnormal status indicating information, the third type of abnormal status indicating information, the fourth type of abnormal status indicating information, and the fifth type of abnormal status indicating information include at least one type of direction icons, gesture icons, face icons, color icons, images and text.

19. The apparatus according to claim 14, wherein:
the first type of abnormal status indicating information, the second type of abnormal status indicating information, the third type of abnormal status indicating information, the fourth type of abnormal status indicating information, and the fifth type of abnormal status indicating information include at least one type of indicator lights, warning tones and graphic icons.

20. The apparatus according to claim 12, further including:
a display mode determination unit configured to determine a current display mode, and control the tracking unit to track the information of the user's face when the current display mode is in a 3D display mode; and
a display mode switching unit configured to, when the information of the user's face is not tracked, switch the 3D display mode to a two-dimensional (2D) display mode.
